(19) United States
(12) Patent Application Publication
(10) Pub. No.: US 2017/0363934 A1
(43) Pub. Date: Dec. 21, 2017

(54) INSTANT PHOTO SYSTEM

(71) Applicants: Debra Stack, Philadelphia, PA (US); Can Boluk, Philadelphia, PA (US)

(72) Inventors: Debra Stack, Philadelphia, PA (US); Can Boluk, Philadelphia, PA (US)

(21) Appl. No.: 15/184,972

(22) Filed: Jun. 16, 2016

(51) Int. Cl. G03B 17/56; A45F 3/02; A47G 1/06; A45F 5/02; A45F 5/00; A45F 3/00

(52) U.S. Cl. CPC G03B 17/561; A47G 1/0616; A45F 5/021; A45F 3/02; A47G 1/0633; A45F 2003/003; A45F 2005/002; A45F 2003/025; A47G 2001/0672; A47G 2001/0677; A47G 2001/0694

(57) ABSTRACT

A wearable mobile apparatus for instant photographs, a frame assembly for the photograph, and a method of providing the instant photograph. The wearable apparatus includes a flexible strap, an attachment on at least one end of the strap; a camera holder hanging from the strap with a pocket for a digital camera; and a printer holder hanging from the strap with a compartment for a portable printer that prints a photograph.

### BACKGROUND OF THE INVENTION

This invention relates to taking mobile instant photographs, and in particular, a wearable apparatus to provide high quality instant photographs in a high quality branded frame to subjects.

People often enjoy having photographs taken at events and parties. Currently, either a photographer will circulate the room with a camera or there will be a backdrop with a photographer taking photographs of subjects and printing the photographs on a stationary printer. The printed photographs often have a logo for the event and perhaps a date. Sometimes, the photographs are placed in low quality frames, where the photo often slides around within the frame or is just discarded by the subject. If the subject takes the low quality frame, it is often discarded.

Photographers who circulate a room with only a camera will often provide digital photographs for subjects via email on a website. The subject may be able to print the photograph after leaving the event, but often the subject is unable to print it because of restrictions. The photographers may also provide the photos to the subjects later during the event, but this usually occurs many minutes after the photograph is taken.

Finally, photographers may use an instant camera to provide onsite photographs to subjects. These photographs take about a minute to dry and are of a low quality and small size of about 2.5″×4″. They are often smudged if touched before they are dry and because of their low quality are not kept by the subject very long.

In view of the current problems faced by photographers at events and subjects attending these events, there is a need to provide a quick, high quality photograph in a high quality frame to subjects. High quality branded framed photographs are more likely to be kept and displayed as a keepsake and are desirable as marketing tools for businesses attending or hosting the events. Providing instant photographs while being mobile is also unobtrusive and fun for guests.

### SUMMARY OF THE INVENTION

One aspect of the invention provides a camera holder that hangs from a strap to be worn by a person, the camera holding having a pocket for a digital camera, a printer holder that hangs from the strap and has a compartment for a portable printer that prints a photograph, and a connection from the digital camera to the printer.

Another aspect of the invention provides a method of providing instant photos comprising providing the instant photo apparatus, taking at least one photograph of a subject with the digital camera at the location, selecting a desired photograph to print, printing the desired photograph with the portable printer at any location, supplying a flexible frame having an inside with an adhesive material covered by a removable backing, an outside opposite the inside, an upper portion an opening from the inside to the outside sized to view a photograph, and a lower portion separated from the upper portion by a fold, removing the removable backing, placing the photograph on the inside of the lower portion such that when the frame is folded, the photograph will be centered within the opening, and folding the frame such that the inside of the upper portion adheres to the inside of the lower portion.

Yet another aspect of the invention provides a frame assembly to receive a photograph comprising an inside with an adhesive material covered by a removable backing, an outside opposite the inside, a flexible upper portion, an opening from the inside to the outside sized to view a photograph, and a flexible lower portion separated from the upper portion by a fold.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1 is a front-side view of one embodiment of the wearable apparatus as worn on a person;

FIG. 2 is a front view of the wearable apparatus of FIG. 1;

FIG. 3 is a front-side view of another embodiment of the wearable apparatus as worn on a person;

FIG. 4 is a front view of the wearable apparatus of FIG. 3;

FIG. 5 is a front-side view of yet another embodiment of the wearable apparatus as worn on a person;

FIG. 6 is a front view of the wearable apparatus of FIG. 5;

FIG. 7 is a front-side view of one embodiment of the frame assembly; and

FIG. 8 is a front view of another embodiment of the frame assembly.

### DETAILED DESCRIPTION OF THE INVENTION

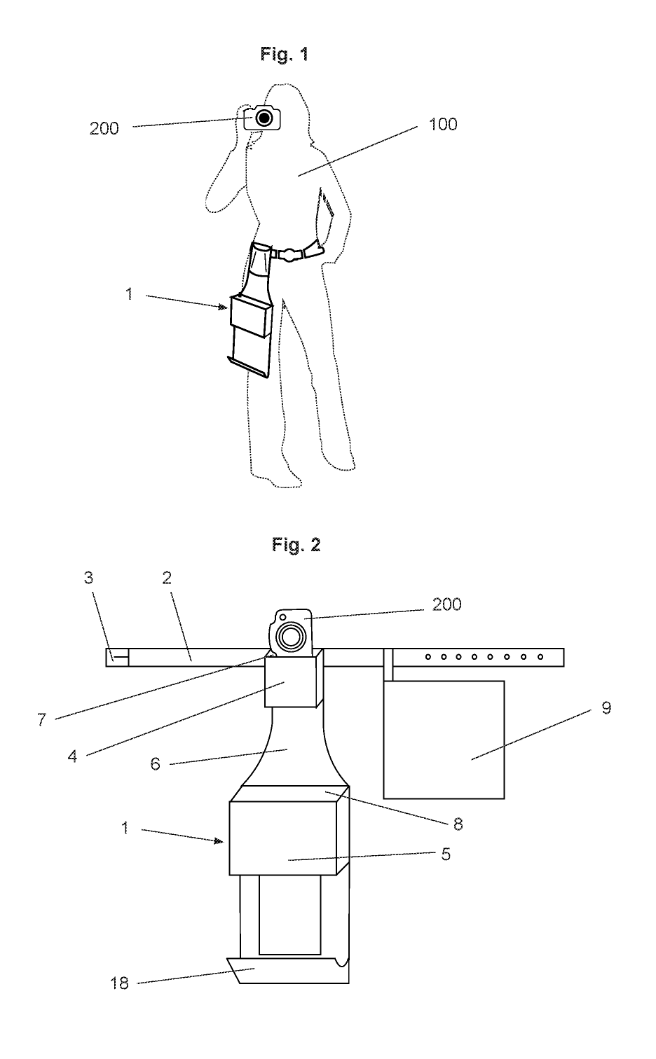

The invention provides a wearable apparatus to deliver an instant photograph, a frame for displaying the instant photograph, and a method of delivering the instant photograph. In one embodiment, as shown in FIGS. 1 and 2, the wearable apparatus 1 has a flexible strap 2 to be worn by a person 100. Preferably, the strap 2 is a belt that is worn around the waist of the person 100. The apparatus may be made of leather, rubber, canvas, vinyl, stretchable material, cotton, plastic, polyester, and/or any other material.

The strap 2 has an attachment 3 on at least one end of the strap 2 to secure the strap 2 around the waist of the person 100. The attachment 2 may be a buckle, snap, button, hook and loop fastener connection, and/or any other type of connection. In one embodiment, the apparatus 1 has a camera holder 4 hanging from the strap 2 with a pocket 7 for a digital camera 200. The apparatus 1 may also have a printer holder 5 hanging from the strap 2 with a compartment 8 for a portable printer that prints a photograph. In one embodiment, the printer holder 5 and camera holder 4 are connected to the strap 2 via one piece 6 hanging from the strap 2.

The apparatus 1 may also have a supplement 18 to support and/or protect a printer paper cassette that holds paper to print the photographs and catches the printed photographs so they do not fall onto the ground. In addition, the apparatus 1 may have a pouch 9. The pouch 9 may be slidably mounted to the strap 2 and can hold any items the photographer may need, including trash, batteries, and/or frames. In a preferred embodiment, the pouch 9 is made of a flexible, lightweight material. The pouch 9 may include a pocket to hold additional items.

In one embodiment, there is a connection from the digital camera to the printer to transfer the photographs taken with the digital camera 200 to the printer for printing the photographs. Preferably, the connection is a wireless signal or a cord.

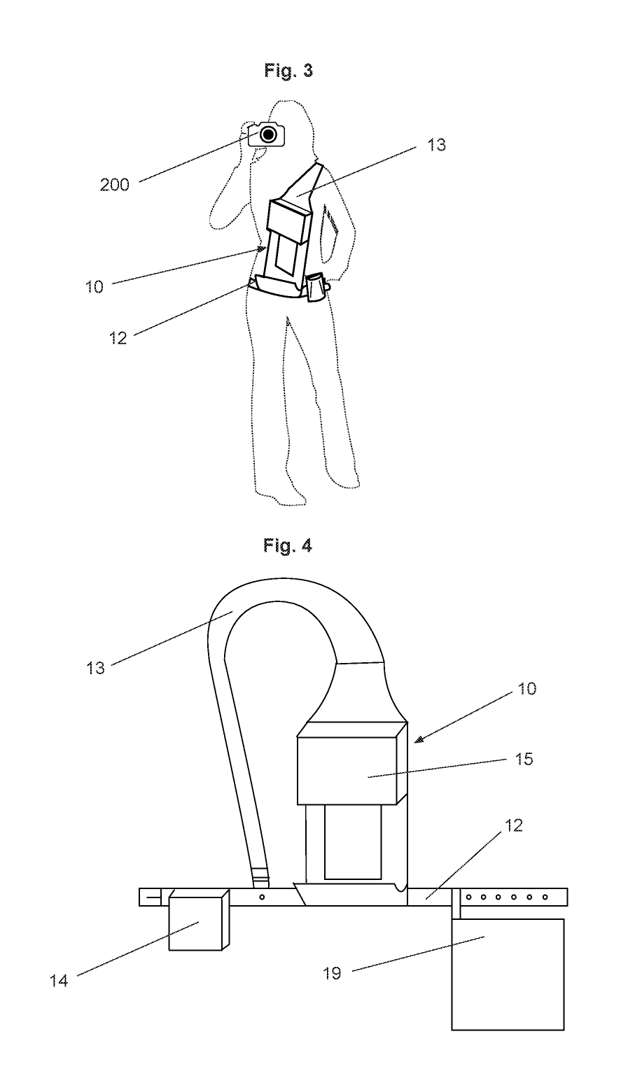

In another embodiment, as shown in FIGS. 3 and 4, the apparatus 10 has a shoulder strap 13 that supports the printer holder 15, which connects with the strap 12 that fits around the waist of the person 100. The shoulder strap 13 may be made of any flexible material that goes over a shoulder of a person 100 to hold the wearable apparatus 10. In this embodiment, the camera holder 14 that holds the digital camera 200 and the pouch 19 is located on the strap 12.

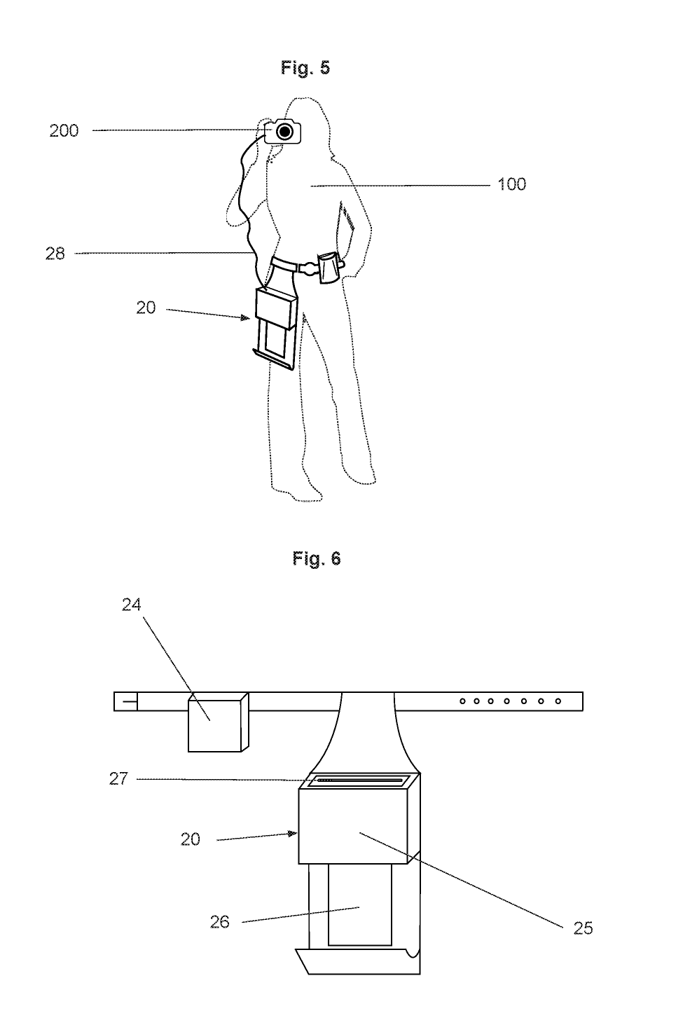

In another embodiment shown in FIGS. 5 and 6, the camera holder 24 is separate from the printer holder 25 when the apparatus 20 is worn by the person 100. The apparatus 20 may have a paper cassette 26 for the printer 27. In one embodiment, the connection 28 from the digital camera to the printer 27 to transfer the photographs is a cord.

The apparatus is used to provide instant photos. A photographer wearing the apparatus is mobile and may take and provide photographs at any location. The location is, preferably, an event with many people, but may be any location where photographs may be taken. Events may be corporate events and parties, trade shows, product promotions, retail grand openings, sporting events, concerts, galas, fundraisers, employee outings, graduations, wedding receptions, family gatherings and reunions, and any other events. In operation, a photographer takes a photograph of a subject, such as a person, place, or thing, with the digital camera at a location. In many instances, the subject will select the desired photograph, but it may also be selected by the photographer or another person. The desired photograph is printed with the portable printer at any location. Any number of photographs may be taken by the photographer and no photographs need to be printed if not desired, and thus, wasted printed photographs are avoided. The photographs may also be stored electronically and may be shown and shared on websites and other electronic media for the subjects to see then or later.

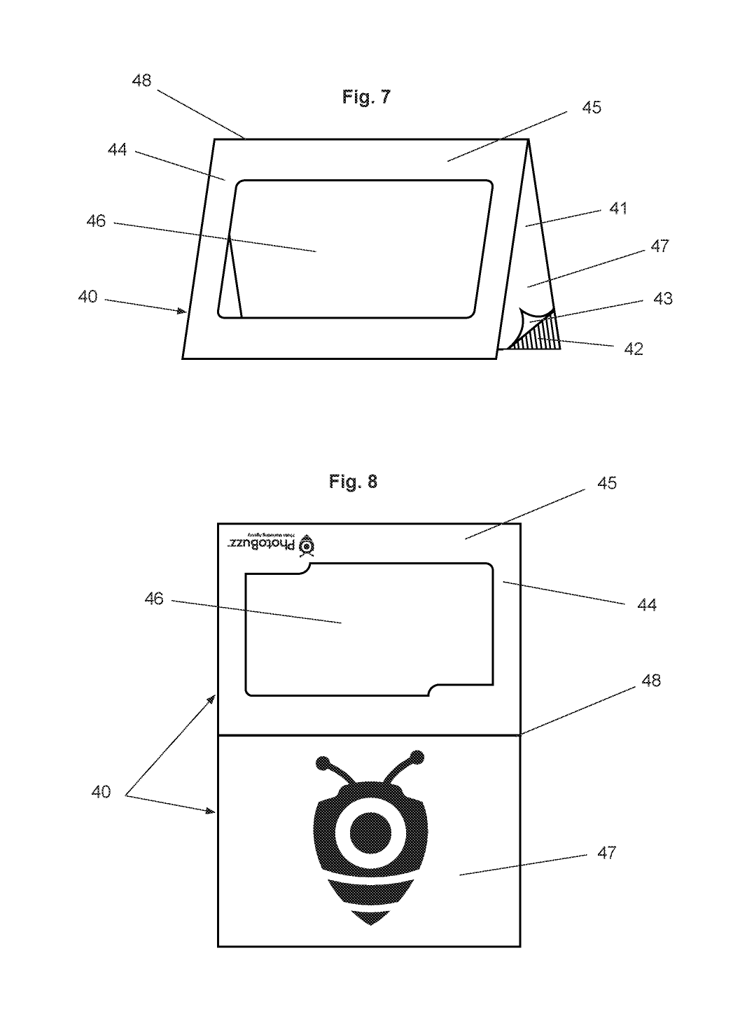

Once the photograph is printed, it may be placed into a frame. As shown in FIG. 7, preferably, the frame 40 is flexible and has an inside 41 with an adhesive material 42 covered by a removable backing 43, an outside 44 opposite the inside 41, an upper portion 45, an opening 46 from the inside 41 to the outside 44 sized to view a photograph, and a lower portion 47 separated from the upper portion 45 by a fold 48. Preferably, the frame is flexible. In one embodiment, the frame 40 is made from 14 pt or heavier card stock. The frame 40 may also have a protective coating. The coating may be used to protect again water damage, fingerprints, wear and tear, or any other possible destruction. The type of coating may be a film laminate or an aqueous coating.

As shown in FIG. 8, the outside 44 of the frame may be used for any type of marketing, advertising, and promotional use. The outside 44 may have a logo, date, marketing information, event information, design, scannable code, coupon, scratch and sniff, scent, texture, scratch off, and/or any other desired information. The frame 40 may be customized in any way desired. The opening 46 and any other part of the frame 40, such as the edges, may also be die cut. In one embodiment, the frame 40 includes a magnet or a stand affixed to the lower portion 47 of the frame so that a subject may hang or prop the frame 40 for display. The frame 40 may be of any size and the opening 46 may be of any size to fit a photo. Preferably, for convenience of the subject to keep the photograph, the frame fits a 4″×6″ photograph. The frame 40 may also be sized for a 5″×7″ photograph or a larger or smaller photograph as desired.

The mobile printing and framing may occur at the same location as where the photograph was taken or at any other location. This feature is particularly convenient for the subjects to receive keepsake photos quickly with the subjects either waiting at the same location where they were photographed or being able to socialize in a nearby location and be able to still receive their photograph in less than a minute. When the photograph is printed, it does not need extra time to dry and can be handled immediately. The time span from the photograph being taken to the photograph being ready in a frame is, preferably, no more than a minute, more preferably, no more than 50 seconds, and most preferably, no more than 40 seconds. In some instances, the process may take no more than 30 seconds or no more than 20 seconds, depending on the technology used.

To place the photograph into the frame, the removable backing 43 is removed. The photograph is placed on the inside of the lower portion 47 such that when the frame 40 is folded along the fold 48, the photograph will be centered within the opening 46. The frame 40 is then folded such that the inside of the upper portion 45 adheres to the inside of the lower portion 47. Because of the adhesive material 42, the photograph will not slide or fall out of the frame 40. The framed photograph may then be given instantly to the subject to display.

Although the invention has been described in detail and with reference to specific embodiments, it will be apparent to one skilled in the art that various changes and modifications can be made without departing from the spirit and scope of the invention. Thus, it is intended that the invention covers the modifications and variations of this invention provided they come within the scope of the appended claims and their equivalents.

What is claimed is:

1. An instant photo apparatus comprising:
a belt that fits around a waist of a person;
an attachment on at least one end of the belt to secure the belt to person;
a camera holder hanging from the belt with a pocket for a digital camera;
a printer holder hanging from the belt with a compartment for a portable printer that prints a photograph;
a connection from the digital camera to the printer; and
a frame having an inside with an adhesive material covered by a removable backing, an outside opposite the inside, an upper portion an opening from the inside to the outside sized to view the photograph, and a lower portion separated from the upper portion by a fold.

2. An instant photo apparatus comprising:
a camera holder that hangs from a strap to be worn by a person, the camera holding having a pocket for a digital camera;
a printer holder that hangs from the strap and has a compartment for a portable printer that prints a photograph; and
a connection from the digital camera to the printer.

3. The instant photo apparatus of claim 2 wherein the strap comprises a belt.

4. The instant photo apparatus of claim 2 wherein the strap comprises an attachment of least one of a buckle, snap, button, and hook and loop fastener connection.

5. The instant photo apparatus of claim 2 further comprising a pouch that hangs from the strap.

6. The instant photo apparatus of claim 5 wherein the pouch slides along the strap.

7. The instant photo apparatus of claim 5 wherein the pouch comprises a flexible, lightweight material that holds at least one of trash, batteries, and frames.

8. The instant photo apparatus of claim 2 wherein the connection comprises at least one of a wireless signal and a cord.

9. The instant photo apparatus of claim 2 wherein the printer prints photographs.

10. The instant photo apparatus of claim 9 further comprising flexible frames for placement of the photographs, each frame having an inside with an adhesive material covered by a removable backing, an outside opposite the inside, an upper portion an opening from the inside to the outside sized to view a photograph, and a lower portion separated from the upper portion by a fold.

11. The instant photo apparatus of claim 2 wherein the person photographs a subject, prints the photograph, places the photograph within the frame, and provides a framed photograph to the subject.

12. A method of providing instant photos comprising:
providing the instant photo apparatus of claim 2;
taking at least one photograph of a subject with the digital camera at the location;
selecting a desired photograph to print;
printing the desired photograph with the portable printer at any location;
supplying a flexible frame having an inside with an adhesive material covered by a removable backing, an outside opposite the inside, an upper portion an opening from the inside to the outside sized to view a photograph, and a lower portion separated from the upper portion by a fold;
removing the removable backing;
placing the photograph on the inside of the lower portion such that when the frame is folded, the photograph will be centered within the opening; and
folding the frame such that the inside of the upper portion adheres to the inside of the lower portion.

13. The method of claim 12 wherein the printing occurs in no more than 40 seconds.

14. The method of claim 12 further comprising providing the framed photograph to the subject at the location.

15. A frame assembly to receive a photograph comprising:
an inside with an adhesive material covered by a removable backing;
an outside opposite the inside;
a flexible upper portion;
an opening from the inside to the outside sized to view a photograph; and
a flexible lower portion separated from the upper portion by a fold.

16. The frame assembly of claim 15 wherein the outside comprises at least one of an advertisement, promotional material, and marketing material.

17. The frame assembly of claim 15 further comprising a die cut on at least one of the opening and edges of the frame assembly.

18. The frame assembly of claim 15 further comprising at least one of a magnet and a stand affixed to the lower portion of the frame.

19. The frame assembly of claim 15 further comprising a protective coating.

20. The frame assembly of claim 15 wherein the upper portion and lower portion comprise a card stock of at least 14 pt.
